(19) United States
(12) Patent Application Publication
(10) Pub. No.: US 2020/0041536 A1
(43) Pub. Date: Feb. 6, 2020

(54) Fibre Optic Vibration and Acceleration Sensor

(71) Applicant: Weidmann Holding AG, Rapperswil (CH)

(72) Inventor: Claus Renschen, Dresden (DE)

(21) Appl. No.: 16/478,498

(22) PCT Filed: Feb. 14, 2018
(86) PCT No.: PCT/EP2018/053642

§ 371 Date: Jul. 17, 2019

(30) Foreign Application Priority Data
Feb. 15, 2017 (DE) 10 2017 202 396.1

(51) Int. Cl. G01P 15/093; G01D 5/353

(52) U.S. Cl. CPC G01P 15/093; G01D 5/353

(57) ABSTRACT

The invention relates to fibre optic vibration and acceleration sensors comprising a dielectric mirror and a first light-guiding fibre connected to a coupler, the coupler being further connected via second light-guiding fibres to a light source and a detector that generates a voltage from incident light.

Said sensors are characterised in particular by their simple implementation.

For this purpose, a free end region of the first fibre is spaced apart from the dielectric mirror such that an edge of the dielectric mirror is located in the emergent light of the first fibre. In the unexcited state, the voltage of the detector generated from the light incident on the end of the first fibre is smaller than the voltage generated by the detector when the aperture cone of the first fibre is completely covered by the dielectric mirror and there is thus maximum reflection. Said voltage is a measure of the fibre optic vibration and acceleration sensor.

A fibre is itself therefore used as a vibration-sensitive element.

### CROSS REFERENCE TO RELATED APPLICATIONS

This application is the U.S. national stage of International Application No. PCT/EP2018/053642, filed on Feb. 14, 2018. The international application claims the priority of DE 102017202396.1 filed on Feb. 15, 2017; all applications are incorporated by reference herein in their entirety.

### BACKGROUND

The invention relates to fibre optic vibration and acceleration sensors comprising a dielectric mirror and a first light-guiding fibre connected to a coupler, the coupler being further connected via second light-guiding fibres to a light source and a detector that generates a voltage from incident light.

A fibre optic vibration sensor is known inter alia from DE 198 01 959 A1 as an optical structure for contactless vibration measurement. The vibration measurement is carried out by means of a laser interferometer having at least one measuring beam and at least one reference beam. The device must have a means for generating a frequency shift.

DE 10 2013 105 483 A1 discloses a vibration sensor, a vibration measuring array, a chemical sensor, and a device comprising same. The vibration sensor has a first resonant element and a first interferometer having a first measuring path and a first reference path. In this case, the first measuring path is formed by a first measuring optical waveguide and the reference path is formed by a first reference optical waveguide. Membranes which are scanned are used for this purpose. Membranes of this kind are expensive to manufacture and their frequency response is difficult to dimension at low frequencies.

U.S. Pat. No. 4,414,471 A discloses a fibre optic sensor comprising a fibre, with two optical waveguides facing one another in one embodiment. An end region is positioned freely in space. During an acceleration, in particular the end moves relative to the other optical waveguide such that the proportion of the light incident thereon changes. In a further embodiment, an arc-shaped mirror is spaced apart from the optical waveguide such that the proportion of the reflected light beams changes as a result of the curvature when the free end of the optical waveguide moves.

DE 10 2015 201 340 A1 discloses a fibre optic vibration sensor in which an optical fibre is used that has a free end that can be deflected by the inertial forces. The fibre end surface at the free end is close to a tilted mirror. If the glass fibre is deflected, more or less light is reflected back into the glass fibre depending on the vibrational state.

DE 195 14 852 A1 discloses a method and an arrangement for acceleration and vibration measurement. An optical fibre is designed as a single-mode fibre. A reflector is spaced closely apart from the end of the fibre in order to bring about a phase change in the measurement signal upon deflection of the fibre end.

EP 0 623 808 A2 includes an optoelectronic sensor device comprising a radiator unit which emits a luminous flux or a radiation of the most uniform possible density. The radiation can flow directly or via an optical medium into an active measuring chamber. The receiver is an optoelectronic component having an active surface that converts the transmitted radiation into an analogue electrical signal.

DE 10 2014 009 214 A1 discloses a fibre optic accelerometer comprising an optical waveguide which forms a cantilevered portion. An optical waveguide stub of which the end is an inclined surface or has a stepped portion is spaced apart therefrom. The opposite end of the optical waveguide stub is cut perpendicularly to the optical axis and coated with a highly polished, efficient, light-reflecting material.

US 2010/0 309 474 A1 includes a gyroscope.

### SUMMARY

The invention relates to fibre optic vibration and acceleration sensors comprising a dielectric mirror and a first light-guiding fibre connected to a coupler, the coupler being further connected via second light-guiding fibres to a light source and a detector that generates a voltage from incident light.

Said sensors are characterised in particular by their simple implementation.

For this purpose, a free end region of the first fibre is spaced apart from the dielectric mirror such that an edge of the dielectric mirror is located in the emergent light of the first fibre. In the unexcited state, the voltage of the detector generated from the light incident on the end of the first fibre is smaller than the voltage generated by the detector when the aperture cone of the first fibre is completely covered by the dielectric mirror and there is thus maximum reflection. Said voltage is a measure of the fibre optic vibration and acceleration sensor.

A fibre is itself therefore used as a vibration-sensitive element.

### DETAILED DESCRIPTION

The problem addressed by the invention specified in claim 1 is that of providing, in a simple manner, a fibre optic vibration and acceleration sensor comprising a light-guiding fibre and a dielectric mirror.

This problem is solved by the features listed in claim 1.

The fibre optic vibration and acceleration sensors comprising a dielectric mirror and a first light-guiding fibre connected to a coupler, the coupler being further connected via second light-guiding fibres to a light source and a detector that generates a voltage from incident light, are characterised in particular by their simple implementation.

For this purpose, a free end region of the first fibre is spaced apart from the dielectric mirror such that an edge of the dielectric mirror is located in the emergent light of the first fibre. In the unexcited state, the voltage of the detector generated from the light incident on the end of the first fibre is smaller than the voltage generated by the detector when the aperture cone of the first fibre is completely covered by the dielectric mirror and there is thus maximum reflection. Said voltage is a measure of the fibre optic vibration and acceleration sensor.

A fibre is itself therefore used as a vibration-sensitive element. The resonant frequencies and sensitivity of the fibre optic vibration and acceleration sensor are determined by the geometry of the fibre, which can be freely selected. For this purpose, the fibre is secured at one end and directed towards a dielectric mirror. The distance between them, and in particular the edge of the dielectric mirror, determines the sensitivity and directional orientation of the fibre optic vibration and acceleration sensor.

The fibre secured at one end is a vibratory structure of which the resonant frequency is determined by the length, diameter and modulus of elasticity. An external force/acceleration at one frequency excites the fibre so as to vibrate at that frequency. The amplitude of the vibration is relatively constant and proportional to the intensity of the excitation in a frequency range smaller than the resonant frequency. This then drastically increases close to the resonant frequency.

The dielectric mirror is arranged opposite the fibre end. When the mirror completely covers the aperture cone of the fibre, a maximum proportion of the light is reflected back into the fibre and generates a voltage in the detector. The sharp-edged dielectric mirror is now adjusted and fixed such that the generated voltage is smaller and the edge of the dielectric mirror is oriented perpendicularly to the gravitational field of the earth.

If the fibre optic vibration and acceleration sensor is now rotated in parallel with the axis of the fibre by + or −90 degrees, the fibre bends on account of its own weight. This changes the coupling relationships between the dielectric mirror and the fibre. The +/− voltage difference Delta U corresponds to the simple gravity of 9.81 m/s² and thus allows easy calibration.

If the fibre optic vibration and acceleration sensor is now excited by mechanical vibrations, the fibre also vibrates at this frequency in the direction of the excitation. Movements by the fibre and the end thereof that are parallel to the edge of the dielectric mirror do not result in any change in the light rays reflected into the fibre end. Movements that are perpendicular to the edge of the dielectric mirror lead to voltage changes at the detector that are proportional to the gravitational acceleration. The sensor is directionally selective.

Another advantage of the fibre optic vibration and acceleration sensor is its insensitivity to electromagnetic fields. The fibre can be made of glass or plastics material.

Advantageous embodiments of the invention are specified in claims 2 to 13.

A first fastening means for the first fibre and a second fastening means for the dielectric mirror are interconnected according to the development of claim 2.

In a continuation of this, according to the development of claim 3, the first fastening means is a sleeve in a tubular part. The dielectric mirror is located on the cross-sectional surface of the tubular part that is opposite the sleeve, and therefore the tubular part is a fastening means of the sleeve and is the second fastening means. This is a simple and compact design of the fibre optic vibration and acceleration sensor. The tube may also have both a circular and a polygonal cross section.

The fibre and the dielectric mirror are connected to the fastening means by gluing and/or clamping according to the development of claim 4. In particular, clamp connections ensure simple fixing of these elements to one another.

According to the development of claim 5, the voltage generated by the detector when the aperture cone of the first fibre is completely covered by the dielectric mirror and there is thus maximum reflection is a first voltage, and the voltage of the detector generated from the light incident on the end of the first fibre in the unexcited state is a second voltage. A change in the second voltage per se and/or in relation to the first voltage signals a vibration or acceleration.

Favourably, in a continuation according to the development of claim 6, the second voltage is 50% of the first voltage. This provides a maximum range of change of the second voltage and thus a maximum measuring range for vibrations or accelerations. The second voltage is in the middle or in the middle range, the amplitude of the vibration being smaller than the resonant frequency and relatively constant and proportional to the intensity of the excitation.

According to the development of claim 7, the dielectric mirror has at least one sharp, straight and smooth edge, which is located in the emergent light of the first fibre.

According to the development of claim 8, the first ends of the second light-guiding fibres are located beside one another in the coupler. Furthermore, the end of the first fibre opposite the free end is arranged at the first ends of the second fibres such that the end of the first fibre overlaps the ends of the second fibres. Moreover, the second end of one second fibre is coupled to the light source and the second end of the other second fibre is coupled to the detector. This is a simple implementation of a coupler, with light from the light source reaching the fibre and then, following reflection at the dielectric mirror, reaching the detector.

According to the development of claim 9, the free end region of the first fibre is a vibratory structure. The resonant frequency of the structure is determined by the length, diameter and modulus of elasticity of the free end region of the first fibre such that an external vibration acting on the fibre optic vibration and acceleration sensor excites the free end region of the first fibre so as to vibrate at the same frequency, the amplitude of the vibration being relatively constant and proportional to the intensity of the excitation in a frequency range smaller than the resonant frequency of the structure, and sharply increasing close to the resonant frequency.

According to the development of claim 10, the second fastening means has at least one guide element for the dielectric mirror, such that the dielectric mirror can be movably guided relative to the end of the first fibre and fastened after positioning. For this purpose, the guide element can advantageously have a rail or a groove. The groove can receive an end region of the dielectric mirror.

According to the development of claim 11, the free end regions of first fibres are spaced apart from the dielectric mirror, the distances of the ends of the first fibres from the edge of the dielectric mirror being different. Furthermore, the first fibres are connected via at least one coupler and light-guiding fibres to at least one detector and at least the light source or one light source in each case.

According to the development of claim 12, the free end regions of first fibres are arranged in parallel with one another and so as to be spaced apart from the dielectric mirror, the ends of the first fibres pointing towards an edge of the dielectric mirror. In addition, the first fibres are connected via at least one coupler and light-guiding fibres to at least one detector and at least the light source or one light source in each case. With this simple design, a wide range of combinations can be realised for a wide variety of applications.

According to the development of claim 13, the free end regions of first fibres are spaced apart from the dielectric mirror. The ends of the first fibres point towards two edges of the dielectric mirror that are arranged an angle to one another. The first fibres are each connected via a coupler and light-guiding fibres to a detector and at least the light source or one light source in each case. The fibre optic vibration and acceleration sensor works in two axes. Furthermore, the first fibres are connected via at least one coupler and light-guiding fibres to at least one detector and at least the light source or one light source in each case.

An embodiment of the invention is schematically shown in each of the drawings and will be described in greater detail below.

### BRIEF DESCRIPTION OF THE DRAWINGS

In the drawings:

FIG. 1 shows a fibre optic vibration and acceleration sensor,

FIG. 2 is a diagram showing amplitude as a function of frequency,

FIG. 3 shows an arrangement of a first glass fibre and a dielectric mirror,

FIG. 4 shows mutually parallel end regions of two first glass fibres with a dielectric mirror, a coupler, a light source, a detector and a control unit,

FIG. 5 shows a dielectric mirror with two parallel light spots produced by two first glass fibres,

FIG. 6 shows a dielectric mirror with two light spots arranged over the corner, produced by two first glass fibres, and

FIG. 7 shows mutually parallel end regions of two first glass fibres with a dielectric mirror, couplers, light sources, detectors and a control unit.

### DETAILED DESCRIPTION OF THE PREFERRED EMBODIMENTS

A fibre optic vibration and acceleration sensor substantially consists of a dielectric mirror 7, a first glass fibre 1 as a first fibre, a coupler 3, a light source 5, a detector 8, and second fibres as a second glass fibre 4 and a third glass fibre 9.

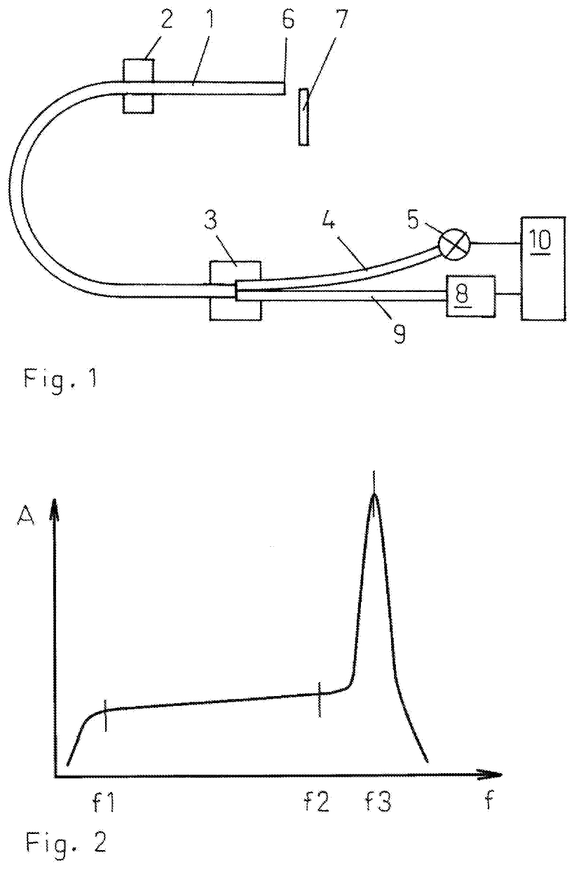

FIG. 1 schematically shows a fibre optic vibration and acceleration sensor.

The first glass fibre 1 it itself used as a vibration-sensitive element, and is secured at one end and directed towards the dielectric mirror 7 for this purpose. The distance between the first glass fibre 1 and the dielectric mirror 7, and the edge thereof, determines the sensitivity and the directional orientation of the fibre optic vibration and acceleration sensor.

The first glass fibre 1 is secured at one end by clamping or gluing in a first fastening means 2 and is connected to a light source 5 by means of the second glass fibre 4 via the coupler 3. For this purpose, the first fastening means 2 may be a body 2 having a bore or recess for receiving a region of the first glass fibre 1. Light from the light source 5, which is preferably a light-emitting diode, is coupled into the first glass fibre 4 via the second glass fibre 4 and the coupler 3 and emerges at the end 6 at an opening angle of approximately 20 degrees. This opening angle corresponds to the numerical aperture of the first glass fibre 1 and can be selected depending on the fibre type. The light reflected by the dielectric mirror 7 is coupled into the first glass fibre 1 and reaches the detector 8 via the coupler 3 and the third glass fibre 9, which detector generates an equivalent electrical voltage therefrom. For this purpose, the first ends of the second glass fibre 4 and the third glass fibre 9 are arranged beside one another in the coupler 3. The end of the first glass fibre 1 opposite the free end is located at the first ends of the second glass fibre 4 and the third glass fibre 9 such that the end of the first glass fibre 1 overlaps the ends of the second glass fibre 4 and the third glass fibre 9.

The light source 5 and the detector 8 are connected to a control unit 10. The latter may be a microcomputer.

FIG. 2 schematically shows a diagram showing amplitude as a function of frequency.

The glass fibre 1 secured at one end is a vibratory structure of which the resonant frequency is determined by the length, diameter and modulus of elasticity. An external force/acceleration at the frequency f excites the first glass fibre 1 so as to vibrate at this frequency f. The amplitude A of the vibration is relatively constant and proportional to the intensity of the excitation between the frequencies f1 and f2, and drastically increases close to the resonant frequency f3.

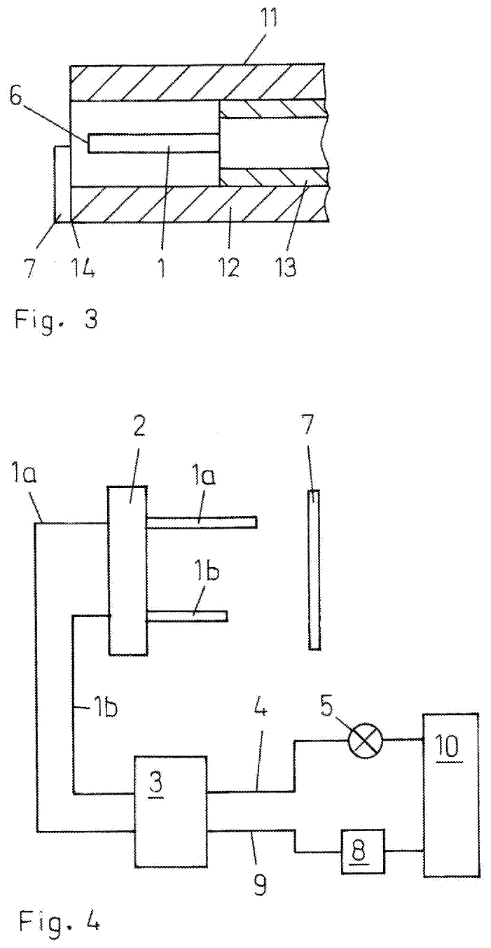

FIG. 3 schematically shows an arrangement of a first glass fibre 1 and a dielectric mirror 7.

The dielectric mirror 7 is spaced apart from the end 6 of the first glass fibre 1. The mirror has a sharp and smooth edge. The dielectric mirror 7 is mechanically connected to the clamping/gluing of the first glass fibre 1. There may, as shown by way of example in FIG. 3, be a tubular part 12 as a second fastening means 11. The first attachment means 2 for the first glass fibre 1 and the second attachment means 11 for the dielectric mirror 7 are interconnected as a sleeve 13 in the tubular part 12 and as the tubular part 12 itself. The sleeve 13 is located in the tubular part 12. Furthermore, the dielectric mirror 7 is arranged on the cross-sectional surface opposite the sleeve 13, and thus on an edge 14 of the tubular part 12.

The mirror is now adjusted and fixed as follows:

When the mirror 7 completely covers the aperture cone of the first glass fibre 1, a maximum proportion of the light is reflected back into the first glass fibre 1 and reaches the detector 8 via the coupler 3 and the third glass fibre 9 and generates an electrical voltage at the detector 8. The sharp-edged dielectric mirror 7 is now adjusted and fixed such that the output voltage of the detector 8 is 50% of the voltage when the aperture cone is completely covered. The sharp edge of the dielectric mirror 7 is oriented perpendicularly to the gravitational field of the earth. During the adjustment, the sharp edge points towards the gravitational field of the earth.

If the tubular part 12 is now rotated in parallel with the axis of the first glass fibre 1 by +90° or−90°, the first glass fibre 1 bends on account of its own weight and changes the coupling relationships between the sharp-edged dielectric mirror 7 and the first glass fibre 1. The resulting voltage difference corresponds to the simple gravity of 9.81 m/s² and thus allows easy calibration.

If the first glass fibre 1 is now excited by mechanical vibrations, it also vibrates at the frequency and in the direction of the excitation. Movements of the first glass fibre 1 and the end 6 thereof that are parallel to the sharp edge of the dielectric mirror 7 do not result in any change in the light intensity on the detector 8, while movements perpendicular to the sharp edge of the dielectric mirror 7 result in voltage changes that are proportional to the gravitational acceleration.

The sensor is therefore directionally selective and insensitive to electromagnetic fields.

Instead of the tubular part 12 as a fastening means, a U-shaped structural element can also be used as a fastening means. The limbs are in this case the first fastening means 2 for the first glass fibre 1 and the second fastening means 11 for the dielectric mirror 7.

The second fastening means 11 can have at least one guide element for the dielectric mirror 7, such that said mirror can be movably guided relative to the end of the first glass fibre 1 and fastened after positioning. Of course, there may also be two guide elements which are mutually spaced such that the dielectric mirror 7 can be movably guided therebetween. After the positioning, the dielectric mirror 7 can be easily adhesively secured in the guide element(s).

FIG. 4 schematically shows mutually parallel end regions of two first glass fibres 1a, 1b with a dielectric mirror 7, a coupler 3, a light source 5, a detector 8 and a control unit 10.

In a first embodiment, in a fibre optic vibration and acceleration sensor, the free end regions of two first glass fibres 1a, 1b are spaced apart from the dielectric mirror 7. The distances of the ends of the first glass fibres 1a, 1b from the edge of the dielectric mirror 7 are the same or different.

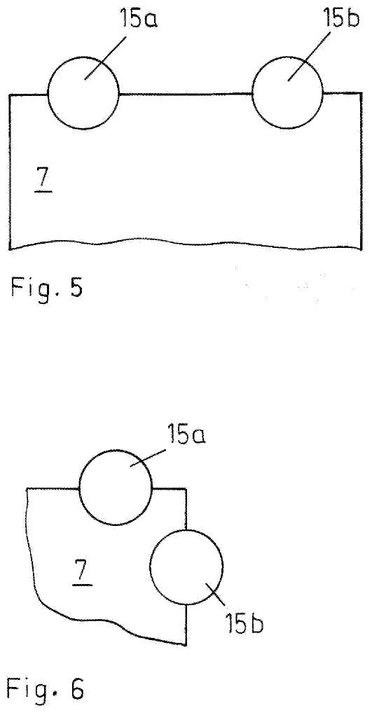

FIG. 5 schematically shows a dielectric mirror 7 with two parallel light spots 15a, 15b produced by two first glass fibres 1a, 1b.

The free end regions of the first glass fibres 1a, 1b can be arranged in parallel with one another and so as to be spaced apart from the dielectric mirror 7 such that the ends of the first glass fibres 1a, 1b point towards an edge of the dielectric mirror 7.

FIG. 6 schematically shows a dielectric mirror 7 with two light spots 15a, 15b produced by two first glass fibres 1a, 1b.

In a first embodiment, in a fibre optic vibration and acceleration sensor, the free end regions of first glass fibres 1a, 1b are spaced apart from the dielectric mirror 7. The ends of the first glass fibres 1a, 1b point towards two edges of the dielectric mirror 7 that are arranged at an angle to one another. FIG. 3 shows the light spots 15a, 15b from the first glass fibres 1a, 1b. The distances of the ends of the first glass fibres 1a, 1b from the dielectric mirror may be the same or different. A vibration or acceleration acting in two axes can thus be measured.

In a first variant, the first glass fibres 1a, 1b of the first and the second embodiment can be connected in each case via a coupler 3 and light-guiding fibres as second glass fibres 4, 9 to at least one detector 8 and at least the light source 5 or one light source 5 in each case.

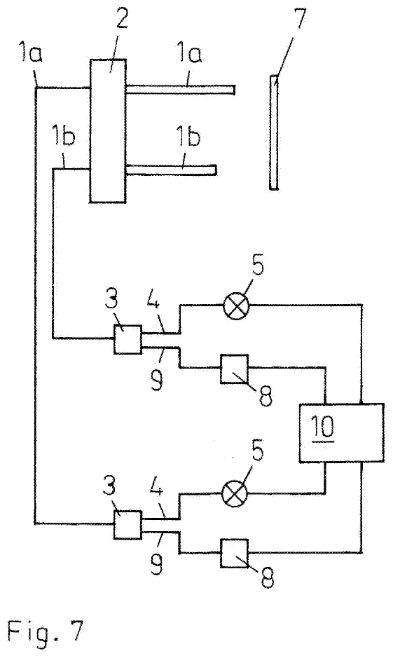

FIG. 7 schematically shows mutually parallel end regions of two first glass fibres 1a, 1b with a dielectric mirror 7, couplers 3, light sources 5, detectors 8 and a control unit 10.

In a second variant, the first glass fibres 1a, 1b of the first and the second embodiment can be connected in each case via a coupler 3 or mixer and light-guiding fibres as second glass fibres 4, 9 to at least one detector 8 and a light source 5. The detectors 8 and the light sources 5 of the first glass fibres 1a, 1b are connected to the control unit 10. The light sources 5 can also be operated in a clocked manner such that it is possible to assign a reflection at the dielectric mirror 7 that can be assigned to the corresponding first glass fibre 1. This can also be done by means of light sources 5 of different wavelengths.

In further variants, a plurality of first glass fibres 1 can each be connected via a coupler 3 or mixer and light-guiding fibres as second glass fibres 4, 9 to at least one detector 8 and a light source 5. The detectors 8 and the light sources 5 of the first glass fibres 1 are connected to the control unit 10. Dielectric mirrors 7 arranged at an angle to one another are arranged for this purpose. For instance, the dielectric mirrors 7 can form an L, T, U or O shape in cross section. This allows measurements to also be made in three axes. The light sources 5 can also be operated in a clocked manner in this case such that it is possible to assign a reflection at the dielectric mirrors 7 that can be assigned to the corresponding first glass fibre 1. This can also be done by means of light sources 5 of different wavelengths.

### LIST OF REFERENCE NUMERALS

1 first glass fibre
2 first fastening means
3 coupler
4 second glass fibre
5 light source
6 end of the first glass fibre
7 mirror
8 detector
9 third glass fibre
10 control unit
11 second fastening means
12 tubular part
13 sleeve
14 edge
15 light spot

1. Fibre optic vibration and acceleration sensor comprising a dielectric mirror (7) and at least a first light-guiding fibre connected to a coupler (3), the coupler (3) being further connected via second light-guiding fibres to a light source (5) and a detector (8) that generates a voltage from incident light, characterised in that a free end region of the first fibre is spaced apart from the dielectric mirror (7) such that an edge of the dielectric mirror (7) is located in the emergent light of the first fibre such that, in the unexcited state, the voltage of the detector (8) generated from the light incident on the end of the first fibre is smaller than the voltage generated by the detector (8) when the aperture cone of the first fibre is completely covered by the dielectric mirror (7) and there is thus maximum reflection, and said voltage is a measure of the fibre optic vibration and acceleration sensor.

2. Fibre optic vibration and acceleration sensor according to claim 1, characterised in that a first fastening means (2) for the first fibre and a second fastening means (11) for the dielectric mirror (7) are interconnected.

3. Fibre optic vibration and acceleration sensor according to claim 2, characterised in that the first fastening means (2) is a sleeve (13) in a tubular part (12), and in that the dielectric mirror (7) is located on the cross-sectional surface of the tubular part (12) that is opposite the sleeve (13), and therefore the tubular part (12) is a fastening means of the sleeve (13) and is the second fastening means (11).

4. Fibre optic vibration and acceleration sensor according to claim 1, characterised in that the fibre and the dielectric mirror (7) are connected to the fastening means (2, 11) by gluing and/or clamping.

5. Fibre optic vibration and acceleration sensor according to claim 1, characterised in that the voltage generated by the detector (8) when the aperture cone of the first fibre is completely covered by the dielectric mirror (7) and there is thus maximum reflection is a first voltage, and the voltage of the detector (8) generated from the light incident on the end of the first fibre in the unexcited state is a second voltage.

6. Fibre optic vibration and acceleration sensor according to claim 5, characterised in that the second voltage is 50% of the first voltage.

7. Fibre optic vibration and acceleration sensor according to claim 1, characterised in that the dielectric mirror (7) has at least one sharp, straight and smooth edge, which is located in the emergent light of the first fibre.

8. Fibre optic vibration and acceleration sensor according to claim 1, characterised in that in the first ends of the second light-guiding fibres are located beside one another in the coupler (3), in that the end of the first fibre opposite the free end (6) is arranged at the first ends of the second fibres such that the end of the first fibre overlaps the ends of the second fibres, and in that the second end of one second fibre is coupled to the light source (5) and the second end of the other second fibre is coupled to the detector (8).

9. Fibre optic vibration and acceleration sensor according to claim 1, characterised in that the free end region of the first fibre is a vibratory structure, and in that the resonant frequency of the structure is determined by the length, diameter and modulus of elasticity of the free end region of the first fibre such that an external vibration acting on the fibre optic vibration and acceleration sensor excites the free end region of the first fibre so as to vibrate at the same frequency, the amplitude of the vibration being relatively constant and proportional to the intensity of the excitation in a frequency range smaller than the resonant frequency of the structure, and sharply increasing close to the resonant frequency.

10. Fibre optic vibration and acceleration sensor according to claim 1, characterised in that the second fastening means (11) has at least one guide element for the dielectric mirror (7), such that the dielectric mirror (7) can be movably guided relative to the end of the first fibre and fastened after positioning.

11. Fibre optic vibration and acceleration sensor according to claim 1, characterised in that the free end regions of first fibres are spaced apart from the dielectric mirror (7), the distances of the ends of the first fibres from the edge of the dielectric mirror (7) being different, and in that the first fibres are connected via at least one coupler (3) and light-guiding fibres to at least one detector (8) and at least the light source (5) or one light source (5) in each case.

12. Fibre optic vibration and acceleration sensor according to claim 1, characterised in that the free end regions of first fibres are arranged in parallel with one another and so as to be spaced apart from the dielectric mirror (7), the ends of the first fibres pointing towards an edge of the dielectric mirror (7), and in that the first fibres are connected via at least one coupler (3) and light-guiding fibres to at least one detector (8) and at least the light source (5) or one light source (5) in each case.

13. Fibre optic vibration and acceleration sensor according to claim 1, characterised in that the free end regions of first fibres are spaced apart from the dielectric mirror (7), and in that the ends of the first fibres point towards two edges of the dielectric mirror (7) that are arranged at an angle to one another, and in that the first fibres are connected via at least one coupler (3) and light-guiding fibres to at least one detector (8) and at least the light source (5) or one light source (5) in each case.
